(19) United States
(12) Patent Application Publication
(10) Pub. No.: US 2022/0369426 A1
(43) Pub. Date: Nov. 17, 2022

(54) High Strain Lead

(71) Applicant: Battelle Memorial Institute, Columbus, OH (US)

(72) Inventors: David R. Chase, Columbus, OH (US); Matthew E. Huntwork, Columbus, OH (US)

(21) Appl. No.: 17/744,559

(22) Filed: May 13, 2022

Related U.S. Application Data
(60) Provisional application No. 63/188,409, filed on May 13, 2021.

(51) Int. Cl. H05B 3/34; B64D 15/12; F03D 1/06; H05B 1/02

(52) U.S. Cl. CPC H05B 3/347; B64D 15/12; F03D 1/0675; H05B 1/0272

(57) ABSTRACT

A resistive heater system comprising a braided and flattened electrical lead connected to a heating blanket or coating at one end of the lead. The braided and flattened electrical lead comprises a folded-over section that forms an angle in the lead of 70 to 110°. The invention also includes an aircraft comprising the heater system. Nonlimiting examples of aircraft include helicopter, drone, and airplane.

### RELATED APPLICATIONS

This application claims the priority benefit of U.S. Provisional Patent Application Ser. No. 63/188,409 filed May 13, 2021.

### INTRODUCTION

The ability to perform reliably under conditions of high strain is a major challenge for electrical leads. This is especially the case for electrical leads to resistive heaters which need to reliably carry high current under difficult conditions on aircraft surfaces. Paulsen et al. in US Pat. No. 10,787,267 describes electrical bus arrangements for ice protection systems located near the leading edge of a blade or wing. The electrical leads can have a J-shape or L-shape or other shape as needed and extend chordwise away from an electrical bus bar.

Shaped electrical connections have been long known, including those made of a conductive metal mesh. For example, Criss et al., in U.S. Pat. No. 4,323,726 describes a design using an elongated strip of a thin metal foil, e.g., copper, silver, gold, aluminum, or platinum, having very low electrical resistance. It is preferred that the member be flexible longitudinally, in a direction normal to its major surface, and in the plane of its major surface. Longitudinal flexibility permits the member to be responsive to temperature-related expansions and contractions of the pattern and substrate. Flexibility in a direction normal to its major surface permits the member to readily conform to the radius of curvature of a non-planar window such as might be used in automotive or aircraft applications.

### DESCRIPTION OF THE INVENTION

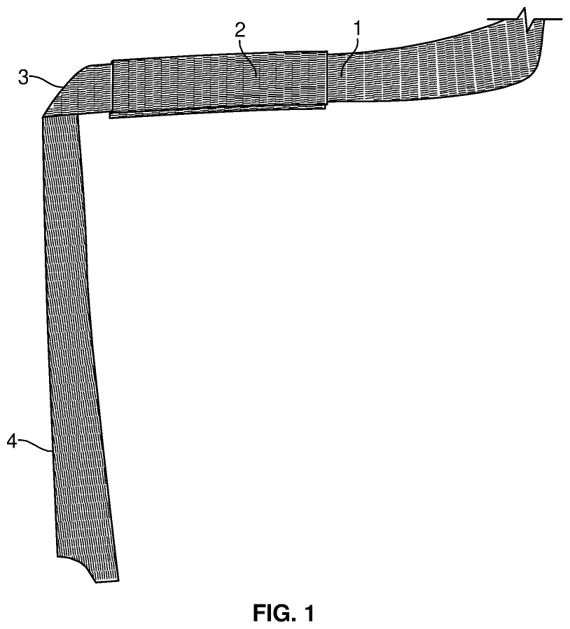

The invention provides a pressed and/or flattened conductive braid that is folded over itself to provide an angle of 70 to 110°, preferably 80 to 100°, or about 90° as shown in the FIG. 1. The folded-over braid provides a flexible joint to connect heater blankets to main bus bars suitable for rotor blade anti-icing applications.

The Criss patent, mentioned above, describes an expanded metallic mesh made from foil; while the inventive high-strain lead is made from metallic braid (typically flattened copper braid). The metal braid material is available by the spool and can be handled easier than foil, making the manufacturing process easier. The metallic braid is innately flexible in the longitudinal and the lateral axes, and no special handling is required during placement on the target surface such as might be required to safely place a cut-foil pattern. Additionally, Criss, et. al., describe an electroconductive layer having volume resistivity less than about 102 ohm-cm interposed between and conformable to the surface configurations of the electroconductive coating that must be fused to the metallic mesh. The inventive high-strain lead invention requires no such electroconductive coating except for the specific case of applying silver epoxy to improve the interface of the metallic braid to a carbon nanotube layer in a particular embodiment. The fold-over corner provides an easy-to-fabricate junction in the lead-to-terminal interface that avoids the complications of bunching depicted in FIG. 3 of Criss, et. al., and observed by us when evaluating the fold-over technique in comparison to other potential junction fabrication methods.

In various embodiments, features and advantages of the invention include:

1. A fold-over technique produces a joint with a profile that is surprisingly lower than that of a radiused bend of similar dimensions due to the bunching of material on the inside of a bend, making the fold-over superior to other joint configurations.
2. Using continuous metallic braid as both the lead and the busbar (electrical contact terminal) reduces the number of joints in the assembly, thereby increasing reliability in addition to simplifying the assembly process.
3. Use of metallic braid improves ease of manufacturing due to simplified acquisition and handling of metallic braid. The invention includes methods of making the system described here.
4. Metallic braid can be compressed in thickness a predetermined proportion to reduce the vertical profile of the material while retaining lateral and longitudinal flexibility.
5. Metallic braid requires no special electroconductive binding material or process throughout the lead travel and fold-over corner so that flexibility longitudinally and laterally is retained.

FIG. 1 illustrates an embodiment of the invention. A copper braid at one end 1 can terminate with a connection to a heater such as a resistive heaters on the surface of an airfoil. An adhesive 2 such as a silver epoxy can bond the braid to a substrate. A 90 degree turn 3 with the pressed braid allows the lead to flex. While other portions of the braid can be bonded to a substrate, the turn portion is free to allow flexibility. The other end of the braid 4 can act like a traditional bus bar to connect to a power source.

A braid is a collection of intertwined fibers or threads, in some preferred embodiments, three or more threads forming a regular diagonal pattern down its length. The conductive braid is preferably made of copper but may be made of other flexible conductive wires that are formed into a braid. The braid structure is also advantageous for good electrical contact to a coating material such as a conductive epoxy or a coating material that forms a resistive heater blanket. A heating blanket (also called a coating) can be any heating blanket; preferred blankets are formed of carbon nanotubes (CNTs).

The continuous length of the braid may include the electrical contact area (buss bar) section of the braid that is intended to be in electrical contact with the heater material; the length between the buss bar and the intended corner location; the folded-over corner; the distance from the corner to either another corner, a system interface connector (typically at the wing or rotor root) if utilized, and the remaining distance to a supply binding location if a connector is not utilized.

The braid could extend from a location on the wing such as the wing tip to power supply interface inside the aircraft fuselage or engine nacelle if an appropriate pass-through is provided where the braid penetrates the aircraft skin.

One type of braid that was evaluated was Hexacon “Hex Wik” W59-25, which is twenty-five feet of un-fluxed copper braid 0.150 inches width before flattening, and available in lengths up to 100 feet. The braid was compressed to a thickness of 0.050 to 0.010 inch. The folded-over region covers a triangular area approximately 0.15 inch at the legs and 0.21 inch at the hypotenuse, with a thickness of approximately 0.024 inch. The braid was secured in place with high-strain epoxy resin materials compatible with the substrate. The braid was interfaced to a carbon nano-tube heater material using a silver epoxy treatment on the braid and direct spray-on of CNT/binder dispersion. Connection to the power source was demonstrated by soldering the braid to a round hook-up wire. In production a connection can be soldered into a solder-cup terminal of a connector such as MIL-DTL-38999 series circular connectors. The thickness of the fold-over corner was 0.025 inch, which is thinner than the rounded-corner of similar radius at 0.028 inch (measurements vary depending on bend radius).

A preferred braid has a length of 10 cm to 30 m, in some embodiments 1 m to 20 m. A preferred braid has a diameter, prior to flattening, of at least 2 mm or at least 3 mm up to 3 cm or 2 cm or 1 cm; and a flattening (reduction) of at least 80% of the diameter or at least 60% of the diameter, or at least 40% of the diameter, or at least 20% of the diameter. At the foldover, the folded-over section preferably forms approximately an isosceles right triangle with sides of at least 2 mm, or at least 4 mm, or at least 6 mm to at most 2 cm or at most 1 cm, and a hypotenuse at least 3 mm, or at least 5 mm, or at least 7 mm to at most 3 cm or at most 2 cm.

On an aircraft, the braid lead could be adhered to the surface of a wing or rotor with or without primer on a dielectric substrate (e.g., fiberglass rotor) or over an electrically insulating layer such as primer on a conductive or semiconductive substrate (e.g., carbon-fiber wing). The braid lead can be countersunk below the wing surface to result in a flush finish surface.

What is claimed:

1. A resistive heater system comprising a high strain lead for high strain applications, comprising:
a resistive heating blanket or coating;
a braided and flattened electrical lead connected to the heating blanket or coating at one end of the lead;
wherein the braided and flattened electrical lead comprising a folded-over section forms an angle in the lead of 70 to 110°.

2. The resistive heater system of claim 1 wherein the braided and flattened electrical lead comprising a folded-over section forms an angle in the lead of 80 to 100°.

3. The resistive heater system of claim 1 wherein the braided and flattened electrical lead comprising a folded-over section forms an angle in the lead of 85 to 95°.

4. The resistive heater system of claim 1 wherein the braided and flattened electrical lead comprises two ends, a first end and a second end, and wherein the first end is connected to the heating blanket or coating and wherein the second end is connected to a power source.

5. The resistive heater system of claim 1 wherein the braided and flattened electrical lead has a length and wherein the braided and flattened electrical lead is attached to a substrate over at least 80% of the length of the braid.

6. The resistive heater system of claim 1 wherein the heating blanket or coating is attached to the surface of an airfoil.

7. The resistive heater system of claim 1 wherein the braided and flattened electrical lead comprises a protective polymeric overcoating.

8. The resistive heater system of claim 1 wherein the braided and flattened electrical lead is a flattened copper braid.

9. The resistive heater system of claim 1 wherein the folded-over section preferably forms approximately an isosceles right triangle with sides of between 2 mm to 2 cm.

10. A rotor blade comprising the resistive heater system of claim 1.

11. An aircraft comprising the resistive heater system of claim 1.

12. The aircraft of claim 11 wherein the aircraft is a helicopter, drone, or airplane.

13. The aircraft of claim 11 wherein the braided and flattened electrical lead is countersunk into the surface of an airfoil.

14. The aircraft of claim 11 where the braid penetrates the aircraft skin

15. The aircraft of claim 11 wherein the braided and flattened electrical lead is not set in a matrix and remains free to stretch.

16. The aircraft of claim 11 wherein an electrical connection between a power source and a resistive heating blanket or coating consists essentially of the braided and flattened electrical lead.

17. The aircraft of claim 11 wherein an electrical connection between a power source and a resistive heating blanket or coating consists of the braided and flattened electrical lead.
